(19) United States
(12) Patent Application Publication
(10) Pub. No.: US 2020/0329133 A1
(43) Pub. Date: Oct. 15, 2020

(54) Accessory for Attachment to a Portable Interactive Programmable Device

(71) Applicants: Sharjeel Surani, Frisco, TX (US); Louis Fabec, Suwanee, GA (US)

(72) Inventors: Sharjeel Surani, Frisco, TX (US); Louis Fabec, Suwanee, GA (US)

(21) Appl. No.: 16/752,549

(22) Filed: Jan. 24, 2020

Related U.S. Application Data
(60) Provisional application No. 62/796,122, filed on Jan. 24, 2019.

(51) Int. Cl. H04M 1/04; A45C 11/00; F16B 1/00

(52) U.S. Cl. CPC H04M 1/04; A45C 11/00; F16B 2001/0035; A45C 2011/002; F16B 1/00

(57) ABSTRACT

An accessory for attachment to a portable interactive programmable device is disclosed. In one embodiment, the accessory includes a base member configured to engage a portion of the portable interactive programmable device. A flexured body member is coupled to the base member and is capable of extending generally along a generally perpendicular axis from the base member and retracting generally along the axis toward the base member. The flexured body member, when extended, has terminal opposition surfaces in which digits hold the flexured body member therebetween. Also, the flexured body member, when extended, is approximately a digit width in axial length. An end member is disposed at the second end of the flexured body member. Each of the base member and end member have a chamber including one of a metal plate and a magnetic plate.

### PRIORITY STATEMENT & CROSS-REFERENCE TO RELATED APPLICATION

This application claims priority from co-pending U.S. Patent Application Ser. No. 62/796,122 entitled “Accessory for Attachment to a Portable Interactive Programmable Device” filed on Jan. 24, 2019, in the names of Sharjeel Surani and Louis Fabec; which is hereby incorporated by reference, in entirety, for all purposes.

### TECHNICAL FIELD OF THE INVENTION

This invention relates, in general, to cellular phone accessories and the like and, in particular, to an accessory for attachment to a portable interactive programmable device.

### BACKGROUND OF THE INVENTION

Cellular phones and other handheld mobile devices continue to increase in size as users demand larger and larger screens. As cellular phones and other handheld mobile devices have increased in size, many users have found the larger screens harder to navigate with one hand. A growing need has emerged for new accessories for cellular phones and other handheld mobile devices that provide a suitable grip.

### SUMMARY OF THE INVENTION

It would be advantageous to achieve an accessory for attachment to a portable interactive programmable device that would improve upon existing limitations in functionality with respect to handling and navigation with a single hand. It would also be desirable to enable a mechanical and materials science-based solution that would provide enhanced performance and improved usability. To better address one or more of these concerns, an accessory for attachment to a portable interactive programmable device, such as a smart phone or smart phone with a case, is disclosed. In one embodiment, the accessory includes a base member configured to engage a portion of the portable interactive programmable device. A flexured body member is coupled to the base member and is capable of extending generally along a generally perpendicular axis from the base member and retracting generally along the axis toward the base member. The flexured body member, when extended, has terminal opposition surfaces in which digits hold the flexure body member therebetween. Also, the flexured body member, when extended, is approximately a digit width in axial length. An end member is disposed at the second end of the flexured body member. Each of the base member and the end member have a chamber including one of a metal plate and a magnetic plate.

In another aspect, an accessory for attachment to a portable interactive programmable device includes a protective case member rather than a base member. The protective case member is configured to engage a portion of the portable interactive programmable device. In still another aspect, an accessory for attachment to a portable interactive programmable device includes a base member configured to engage a portion of the portable interactive programmable device. A body member is coupled to the base member and is capable of extending generally along a perpendicular axis from the base member and retracting generally along the axis toward the base member. The body member, when extended, has terminal opposition surfaces in which digits hold the body member therebetween. Further, the body member, when extended, is approximately a digit width in axial length. An end member is disposed at the second end of the body member. Each of the base member and end have a chamber including one of a metal plate and a magnetic plate.

In this embodiment, the body member may be a flexured body member, a flexured body member tapered from one end to the other, a flexured body member having moveable coaxial rings therein, or a cord secured to a cord retraction assembly, for example. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a side perspective view illustrating one embodiment of an accessory for attachment to a portable interactive programmable device according to the teachings presented herein being utilized;

FIG. 2 is a side perspective view illustrating another embodiment of the accessory for attachment to a portable interactive programmable device depicted in FIG. 1 being utilized;

FIG. 3 is a rear bottom perspective view illustrating the accessory depicted FIG. 1;

FIG. 4 is a side elevation view of the accessory depicted in FIG. 1 in an extended position;

FIG. 5 is a side elevation view of the accessory depicted in FIG. 1 in a retracted position;

FIG. 6 is a side elevation view, in section, of the accessory depicted in FIG. 1;

FIG. 7 is a top perspective view, partially exploded, of the accessory depicted in FIG. 1;

FIG. 8 is a top perspective view, in section and partially exploded, of the accessory depicted in FIG. 1;

FIG. 9 is a bottom perspective view, partially exploded, of the accessory depicted in FIG. 1;

FIG. 10 is a side elevation view, in section, of another embodiment of an accessory for attachment to a portable interactive programmable device, according to the teachings presented herein;

FIG. 11 is a side elevation view, in section, of still another embodiment of an accessory for attachment to a portable interactive programmable device, according to the teachings presented herein; and

FIG. 12 is a side elevation view of an accessory including a protective case member for attachment to a portable interactive programmable device, according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

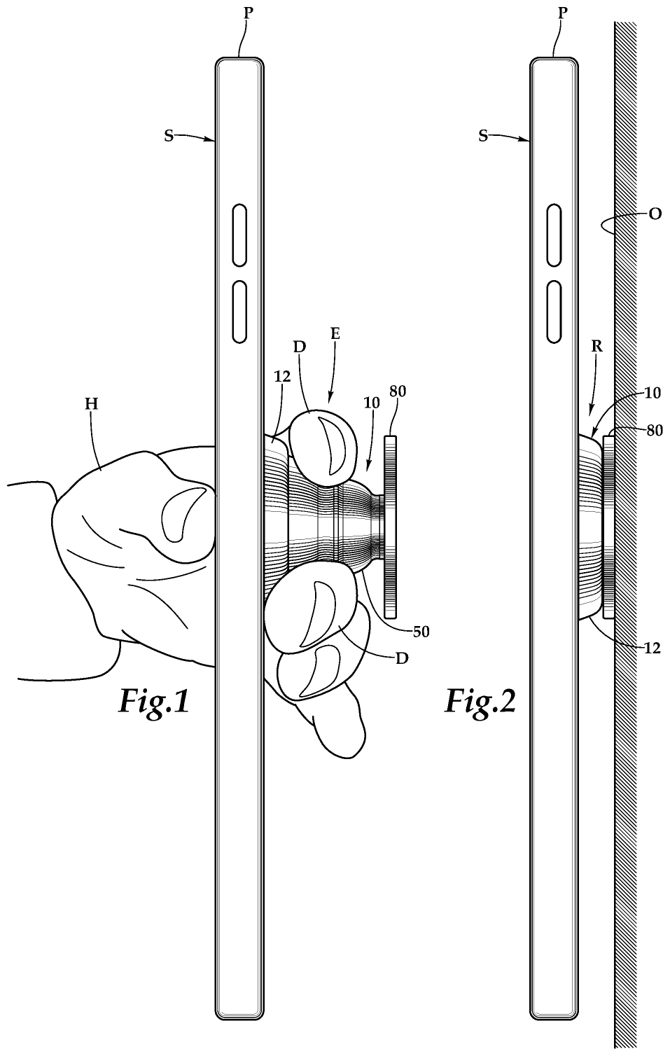

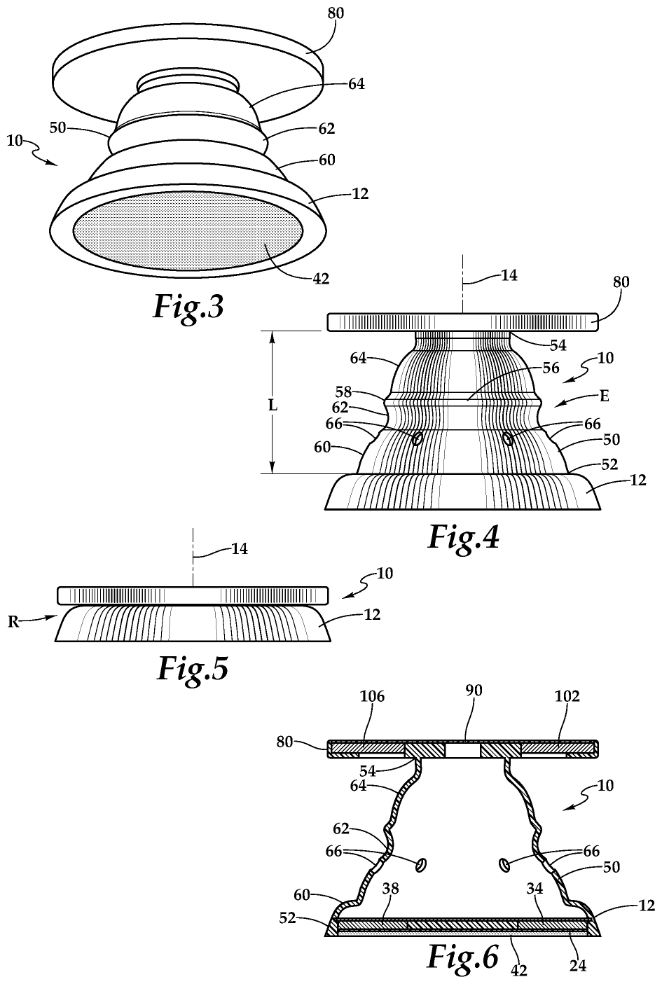

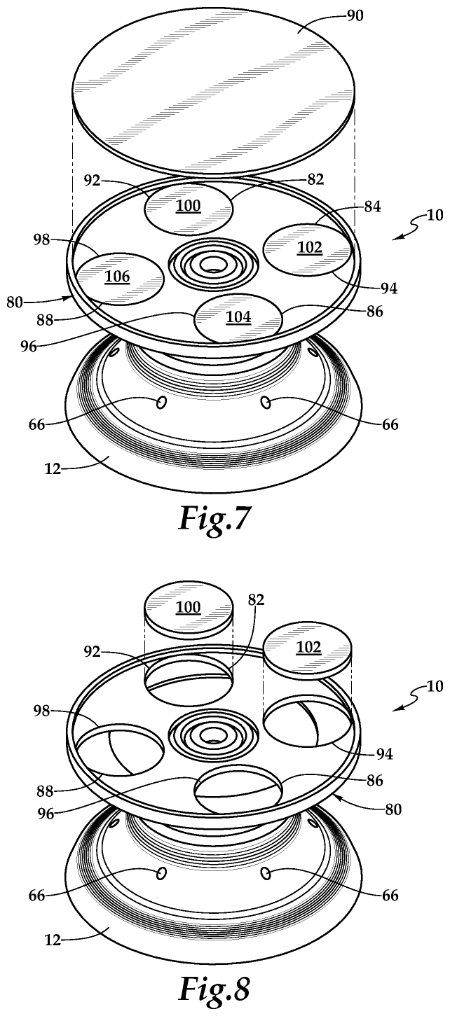

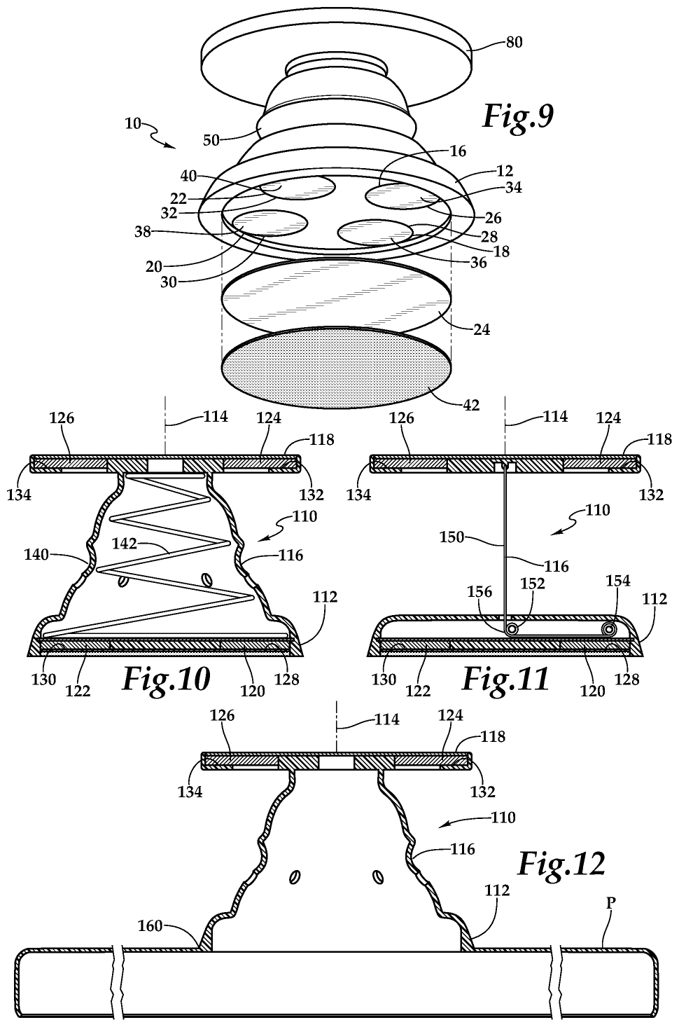

Referring initially to FIG. 1 through FIG. 9, therein is depicted one embodiment of an accessory for attachment to a portable interactive programmable device, which is schematically illustrated and designated 10. As shown, the accessory 10 is attached to a smart phone S. It should be appreciated, however, that the smart phone S represents any type of portable interactive programmable device and may be any type of electronic device such as the aforementioned smart phone or a tablet computer, for example. Further, as illustrated, the accessory 10 may be secured to a protective case member P associated with the smart phone S. In one embodiment, the accessory 10 includes a base member 12 configured to engage a portion of the protective case member P of the smart phone S. The base member 12 has an axis 14 perpendicular to the protective case member P of the smart phone S. As shown, the base member 12 includes chambers 16, 18, 20, 22 defined by cover 24 and respective slots 26, 28, 30, 32. A magnetic plate 34, a metal plate 36, a magnetic plate 38, and a metal plate 40 are respectively located within the chambers 16, 18, 20, 22. It should be appreciated that any number and configuration of chambers may be present within the base member 12. Additionally, any combination of magnetic plates and metal plates or exclusively magnetic plates or exclusively metal plates may be utilized. In one implementation, an adhesive layer 42 is located on the base member 12 to provide adhesion to the smart phone S or protective case member P, for example.

A flexured body member 50 includes ends 52, 54 and is coupled to the base member 12 at the end 52. The flexured body member 50 is capable of extending generally along the axis 14 from the base member 12 and retracting generally along the axis 14 toward the base member 12. The flexured body member 50, extended, includes terminal opposition surfaces 56, 58 in which digits D of a hand H hold the flexured body member 50 therebetween. In one embodiment, the flexured body member 50, extended, is approximately a digit width in axial length L at the axis 14 from the end 52 to the end 54.

As shown, the flexured body member 50 may be tapered from the end 52 to the end 54. The flexured body member 50 may include segments 60, 62, 64 that provide folding sections having walls and hinges or bendable portions. Vents 66 provide for the movement of air during expansion and contraction. In one implementation, the segment 64 may collapse and expand from the segment 62, which in turn collapses and expands from the segment 60.

An end member 80 is disposed at the end 54 of the flexured body member 50. The end member includes chambers 82, 84, 86, 88 defined by cover 90 and respective slots 92, 94, 96, 98. A magnetic plate 100, a metal plate 102, a magnetic plate 104, and a metal plate 106 are respectively located within the chambers 82, 84, 86, 88. It should be appreciated that any number and configuration of chambers may be present within the end member 80. Additionally, any combination of magnetic plates and metal plates or exclusively magnetic plates or exclusively metal plates may be utilized.

In operation, the accessory 10 for attachment to a portable interactive programmable device, such as a smart phone or tablet computer, may be utilized in an extended position E to provide for increased functionality with respect to handling and navigation with a single hand. Also, the accessory 10 may be collapsed in a retracted position R to provide an improved form function with respect to storage and placement, such as placement on surface O. In particular, in embodiments where the accessory 10 has magnetic plates and metal plates positioned at the base member 12 and the end member 80, the accessory 10 may interact with a wide variety of surroundings. By way of example and not by way of limitation, with the appropriate configuration of magnetic plates and metal plates at the base member 12 and the end member 80, the accessory 10 may be releasably attached to a protective case member P and, on the other side, releasably attached to a variety of metallic and metal surfaces.

Referring now to FIG. 10 and FIG. 11, in one embodiment, an accessory 110 for attachment to a portable interactive programmable device includes a base member 112 configured to engage a portion of a portable interactive programmable device, such as a smart phone, a smart phone case, a tablet computer, or a tablet computer case, for example. The base member 112 has an axis 114 perpendicular thereto. The base member 112 includes chambers 120, 122 for securing a magnet 128 and metal plate 130 therein. It should be appreciated, however, that any combination of magnets and metal plates may be utilized. A body member 116 is coupled to the base member 112 as well as an end member 118. The body member 116 is capable of extending generally along the axis 114 from the base member 112 and retracting generally along the axis 114 toward the base member 112. The body member 116, extended, has terminal opposition surfaces in which digits D hold the body member 116 therebetween. In one implementation, the body member 116, extended, is approximately a digit width in axial length. The end member 118 includes at least one chamber for a combination of magnetic plates and metal plates. As shown, the end member 118 includes chambers 124, 126 respectively including a magnetic plate 132 and a metal plate 134.

The body member 116 may be of various types and by way of non-limiting example, the body member 116 may be a flexured body member 140 or a tapered flexured body member that is tapered from one end to the other. Further, in one embodiment, which is best illustrated in FIG. 10, the body member 116 may include multiple coaxial rings 142 that move relative to one another as the body member 116 extends and retracts along the axis 114. The multiple coaxial rings 142 may act as a spring in the retraction and extension of the body member 116. In another embodiment, which is best illustrated in FIG. 11, the body member 116 may include a cord 150 secured to a cord retraction assembly 152 mounted to the base member 112. The cord retraction assembly 152 is configured to control the amount that the cord 150 is pulled from the cord retraction assembly 152 to allow the end member 118 to be selectably movable between extension and retraction. In one embodiment, the cord retraction assembly 152 includes a spool 154 suppling a supply of cord to an axel and wheel pulley 156. It should be appreciated that the body member 116 may have different forms that provide for the expansion and retraction of the end member 118 relative to the base member 112. The examples presented herein of body members are non-limiting examples and other types of body members are also within the teachings presented herein.

Referring now to FIG. 12, in one embodiment of an accessory 110 for attachment to a portable interactive programmable device, the accessory 110 is incorporated with a protective case member P configured to engage a portion of the portable interactive programmable device, such as a smart phone or a tablet computer. Similar to previously discussed embodiments, the base member 112 has an axis 114 perpendicular thereto. The base member 112 may be integrally coupled to the protective case member P as shown by reference numeral 160. The body member 116 is coupled to the base member 112 as well as an end member 118. The body member 116 is capable of extending generally along the axis 114 from the base member 112 and retracting generally along the axis 114 toward the base member 112. The body member 112, extended, has terminal opposition surfaces in which digits D hold the body member 116 therebetween. In one implementation, the body member 116, extended, is approximately a digit width in axial length. The end member 118 includes at least one chamber for a combination of metal plates and magnetic plates. As shown, the end member 118 includes the chambers 124, 126 respectively including the magnetic plate 132 and the metal plate 134. It should be appreciated that any form of the body member 116 may be utilized with this embodiment where the base member 112 is incorporated into the protective case member P.

The order of execution or performance of the methods and techniques illustrated and described herein is not essential, unless otherwise specified. That is, elements of the methods and techniques may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. An accessory for attachment to a portable interactive programmable device, the accessory comprising:
a base member configured to engage a portion of the portable interactive programmable device, the base member having an axis perpendicular thereto, the base member including a first chamber;
a flexured body member having a first end and a second end, the flexured body member coupled to the base member at the first end, the flexured body member capable of extending generally along the axis from the base member and retracting generally along the axis toward the base member;
the flexured body member, extended, having terminal opposition surfaces in which digits hold the flexured body member therebetween, the flexured body member, extended, being approximately a digit width in axial length;
an end member disposed at the second end of the flexured body member, the end member including a second chamber; and
each of the first chamber and the second chamber including one of a metal plate and a magnetic plate.

2. The accessory as recited in claim 1, wherein the base member further comprises a third chamber.

3. The accessory as recited in claim 2, wherein the third chamber further comprises a metal plate.

4. The accessory as recited in claim 2, wherein the third chamber further comprises a magnetic plate.

5. The accessory as recited in claim 1, wherein the end member further comprises a fourth chamber.

6. The accessory as recited in claim 5, wherein the fourth chamber further comprises a metal plate.

7. The accessory as recited in claim 5, wherein the fourth chamber further comprises a magnetic plate.

8. The accessory as recited in claim 1, wherein the portable interactive programmable device further comprises a device selected from the group consisting of smart phones and tablet computers.

9. The accessory as recited in claim 1, wherein the flexured body member is tapered from the first end to the second end.

10. The accessory as recited in claim 1, wherein the flexured body member further comprises a plurality of at least partially coaxial rings that move relative to one another as the flexured body member extends and retracts along the axis.

11. An accessory for attachment to a portable interactive programmable device, the accessory comprising:
a protective case member configured to engage a portion of the portable interactive programmable device;
a flexured body member having a first end and a second end, the flexured body member coupled to the protective case member at the first end, the flexured body member capable of extending generally along a perpendicular axis from the protective case member and retracting generally along the perpendicular axis toward the protective case member;
the flexured body member, extended, having terminal opposition surfaces in which digits hold the flexured body member therebetween, the flexured body member, extended, being approximately a digit width in axial length;
an end member disposed at the second end of the flexured body member, the end member including a chamber; and
the chamber including one of a metal plate and a magnetic plate.

12. The accessory as recited in claim 1, wherein the end member further comprises a second chamber.

13. The accessory as recited in claim 12, wherein the second chamber further comprises a metal plate.

14. The accessory as recited in claim 12, wherein the fourth chamber further comprises a magnetic plate.

15. The accessory as recited in claim 1, wherein the flexured body member is tapered from the first end to the second end.

16. An accessory for attachment to a portable interactive programmable device, the accessory comprising:
a base member configured to engage a portion of the portable interactive programmable device, the base member having an axis perpendicular thereto, the base member including a first chamber;
a body member having a first end and a second end, the body member coupled to the base member at the first end, the body member capable of extending generally along the axis from the base member and retracting generally along the axis toward the base member;
the body member, extended, having terminal opposition surfaces in which digits hold the body member therebetween, the body member, extended, being approximately a digit width in axial length;
an end member disposed at the second end of the body member, the end member including a second chamber; and
each of the first chamber and the second chamber including one of a metal plate and a magnetic plate.

17. The accessory as recited in claim 16, wherein the body member further comprises a flexured body member.

18. The accessory as recited in claim 16, wherein the body member further comprises a flexured body member tapered from the first end to the second end.

19. The accessory as recited in claim 18, wherein the flexured body member further comprises a plurality of at least partially coaxial rings that move relative to one another as the flexured body member extends and retracts along the axis.

20. The accessory as recited in claim 16, wherein the body member further comprises a cord secured to a cord retraction assembly mounted to the base member, the cord retraction assembly configured to control the amount that the cord is pulled from the cord retraction assembly to allow the end member to be selectably movable between extension and retraction.
